(19) United States
(12) Patent Application Publication
(10) Pub. No.: US 2006/0211448 A1
(43) Pub. Date: Sep. 21, 2006

(54) Method and apparatus of conveying information over a mobile and fixed networks

(75) Inventors: Ron Reiss, Tel Aviv (IL); Eyal Goltzman, Givatayim (IL); Philippe Klein, Jerusalem (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: OneCell Ltd.

(21) Appl. No.: 11/247,876

(22) Filed: Oct. 11, 2005

Related U.S. Application Data
(60) Provisional application No. 60/593,561, filed on Jan. 26, 2005.

(51) Int. Cl. H04M 1/00

(52) U.S. Cl. 455/553.1

(57) ABSTRACT

An intermediate server for conveying information, the intermediate server includes: an intermediate network interface, for receiving signals provided from a mobile phone to an access point and further conveyed over an intermediate network; wherein the signals are provided by the mobile phone over an unlicensed medium; wherein the intermediate network interface is further adapted to communicate with an intermediate network manager such as to guarantee an allocation of intermediate resources to the exchange of signals; a fixed network interface, for exchanging signals with a fixed network; and at least one translation component, adapted to apply translation mechanisms from a mobile phone protocol to a fixed network protocol. A method for conveying information, the method includes: receiving-a request to transfer information between a mobile phone and fixed network; selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols; and transferring the information while applying the translation mechanism; wherein the transferring includes exchanging signals between the mobile phone and an access point over an unlicensed wireless medium and exchanging signals between the access point and an intermediate server over an intermediate network.

### RELATED APPLICATIONS

This application is a non-provisional of, related to and claims the priority benefit of U.S. Provisional Application No. 60/593,561, filed Jan. 26, 2005 which is incorporated herein by reference.

### BACKGROUND OF THE INVENTION

Traditional mobile networks (also referred to as licensed wireless networks) were designed to convey voice over wireless medium. The mobile network infrastructure includes multiple base stations that define mobile network coverage areas that are also known as cells. When a mobile phone moves between cell that belong to the same mobile network a handoff operation is performed.

In order to expand the coverage area of mobile network multiple unlicensed wireless network infrastructures were developed. U.S. Pat. No. 6,647,426 of Muhammed titled “Apparatus and method for integrating an unlicensed wireless communication system and a licensed wireless communication system”, which is incorporated herein by reference describes a handover based mechanism for expanding the coverage area of mobile networks. Unlicensed wireless networks are characterized by a relatively short range. Kineto Networks from Milpitas California, introduced a mobile phone that uses a UMA protocol (also known as 3GPP GA) that enables the mobile phone to exchange signals with an access point that participates in a handoff between a mobile network cell and a virtual cell that is defined by the access point.

Various mobile networks can convey in an efficient manner both voice and data. For example, a GSM or CDMA compliant mobile network includes Short Message Service (SMS) channels as well as GRPS or IS-95 data conveying channels.

The Internet Protocol communication protocol and the TCP/IP (or UDP/IP) protocol stacks are the most dominant protocols of data networks. The mobile domain is expected to merge with the IP domain within the next few years. The merger is expected to be based upon Initiation Protocol (SIP) and IP Multimedia Subsystems (IMS).

There is a growing need to provide efficient systems and methods for conveying ion between mobile phones and various networks.

### SUMMARY OF THE INVENTION

An intermediate server for conveying information, the intermediate server includes: an intermediate network interface, for receiving signals provided from a mobile phone to an access point and further conveyed over an intermediate network; wherein the signals are provided by the mobile phone over an unlicensed medium; wherein the intermediate network interface is further adapted to communicate with an intermediate network manager such as to guarantee an allocation of intermediate resources to the exchange of signals; a fixed network interface, for exchanging signals with a fixed network; and at least one translation component, adapted to apply translation mechanisms from a mobile phone protocol to a fixed network protocol.

A method for conveying information, the method includes: receiving a request to transfer information between a mobile phone and fixed network; allocating intermediate network resources for transferring the information in response to a type of the information; and transferring the information while applying a translation mechanism between a mobile phone protocol and a fixed network protocol wherein the transferring includes: exchanging signals between the mobile phone and an access point over an unlicensed wireless medium and exchanging signals between the access point and an intermediate server over the intermediate network.

An intermediate server for conveying information, the intermediate server includes: an intermediate network interface, for receiving signals provided from a mobile phone to an access point and further conveyed over an intermediate network; wherein the signals are provided by the mobile phone over an unlicensed medium; a fixed network interface, for exchanging signals with a fixed network; at least one translation component, adapted to apply a group of translation mechanisms that translate multiple mobile phone protocols to multiple fixed network protocols; and a controller, adapted to select a translation mechanism out of the group of translation mechanisms, in response to a request to transfer information between a mobile phone and fixed network.

A method for conveying information, the method includes: receiving a request to transfer information between a mobile phone and fixed network; selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols; and transferring the information while applying the translation mechanism; wherein the transferring includes exchanging signals between the mobile phone and an access point over an unlicensed wireless medium and exchanging signals between the access point and an intermediate server over an intermediate network.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates an intermediate server and its environment, according to an embodiment of the invention;

FIG. 2 is a detailed illustration of an intermediate server and its environment, according to an embodiment of the invention;

FIG. 3 is another detailed illustration of an intermediate server and its environment, according to an embodiment of the invention;

FIG. 4 is a detailed illustration of a translation component according to an embodiment of the invention;

FIG. 5 is a detailed illustration of another translation, according to an embodiment of the invention;

FIG. 6 illustrates various communication protocol stacks, according to an embodiment of the invention;

FIG. 7 illustrates various signals exchanged between the intermediate server and various entities, according to an embodiment of the invention;

FIG. 8 illustrates a sequence 500 that control the initialization of a call from mobile phone, according to an embodiment of the invention;

FIG. 9 illustrates a sequence that control the initialization of a call from a SIP network, according to an embodiment of the invention;

FIG. 10 is a flow chart of a method according to an embodiment of the invention; and

FIG. 11 is a flow chart of a method according to an embodiment of the invention.

### DETAILED DESCRIPTION OF THE INVENTION

For simplicity of explanation the following detailed description refers to search queries that include two keywords. It is noted that method can be applied mutates mutandis to search queries that include more than two keywords.

The term “mobile phone” as used throughout the specification relates to a mobile device that can exchange various types of information (and at least voice signals) over a wireless medium. In is noted that these mobile devices can be integrated within various mobile devices such as personal data accessories and the like.

The following abbreviations are used in this document: AKA: Authentication and Key Agreement, AP: Access Point, CC: Call Control, CDMA: Code Division Multiple Access, CM: Connection Management, GA: Generic Access, GAN: Generic Access Network, GANC: Generic Access Network Controller, GA-RC: Generic Access Resource Control, GA-CSR: Generic Access Circuit Switched Resources, GA-PSR: Generic Access Packet Switched Resources, GMM/SM: GPRS Mobility Management and Session Management, GPRS: General Packet Radio Service, GSM: Global System for Mobile communications, GSN: GPRS Support Node, HLR: Home Location Register, MM: Mobility Management, PLMN: Public Land Mobile Network, SGSN: Serving GPRS Support Node and SNDCP: Sub-Network Dependent Convergence Protocol; SIP: Session Initiation Protocol, UMA: , 3GPP: Third Generation Partnership Project, MAP: Mobile Application Part, PLNM: Public Land Mobile Network, UMTS: Universal Mobile Telecommunication System, RTP: Real Time Protocol, CC: Call Control, MM: Mobility Management, CMS: Call Management System , OSS/BSS: Operational Support Systems/Business Support Systems , EAP-SIM: Extended Authentication Protocol -Subscriber Identity Module RC: Radio Control, PC: Packet Control, GA-CSR: Generic Access Circuit Switched Resources, GPRS-DATA: General Packet Radio Service - Data, PSR-INITDATA: Packet Switch Resource Data and IPSec: Internet Protocol Security.

The following figures illustrates various types of mobile phone including IMS compliant mobile phones, GSM compliant mobile phones, CDMA compliant phones, SIP compliant mobile phones, UMTS compliant phones and 3GPP GA compliant mobile phones. These mobile phones can communication using various mobile phone protocols including data conveying protocols, signaling and control protocols, voice conveying protocols such as but not SIP, CDMA, GSM, GPRS, 3GPP GA, and the like. All these mobile phone types and mobile phone protocols are exemplary and are provided for convenience of explanation.

The following figures also illustrates various types of fixed network that include voice over internet protocol (VoIP) network, internet protocol (IP) data network, and IMS network. Those of skill in the art will appreciate that the invention can be applied to other mobile phone protocols as well as other fixed networks. These networks can use various communication protocols as well as signaling and management protocols such as IP, TCP, UDP, RTP, MAP, SCTP and the like.

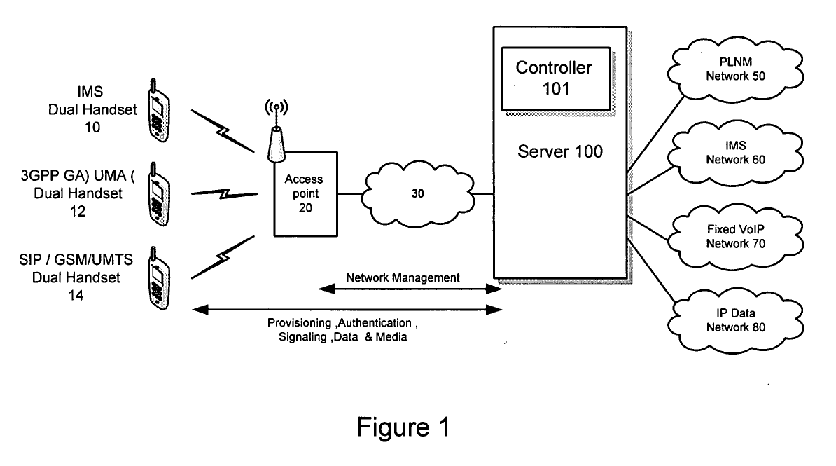

FIG. 1 illustrates an intermediate server 100 and its environment, according to an embodiment of the invention.

Intermediate server 100 is connected to various fixed networks such as IP data network 80, fixed VoIP network 70, IMS network 60 and to a mobile network such as PLNM network 50. Intermediate server 100 is also connected to intermediate network 30 that in turn is connected to access point 20. The access point can exchange signals with mobile phones of various types, over a wireless unlicensed medium. The mobile phones are an IMS mobile phone 10, a 3GPP GA mobile phone and a SIP/GSM/CDMA/UMTS mobile phone 14. It is noted that the number and/or type of mobile phones that communicates with access point 20 can differ from those three mobile phones that are illustrated in this figure. Once the mobile phone enters the coverage area of the access point 20 a roaming sequence can be initiated such as to allow a fixed network to manage a previously initiated information exchange session. This session can also be referred to as call.

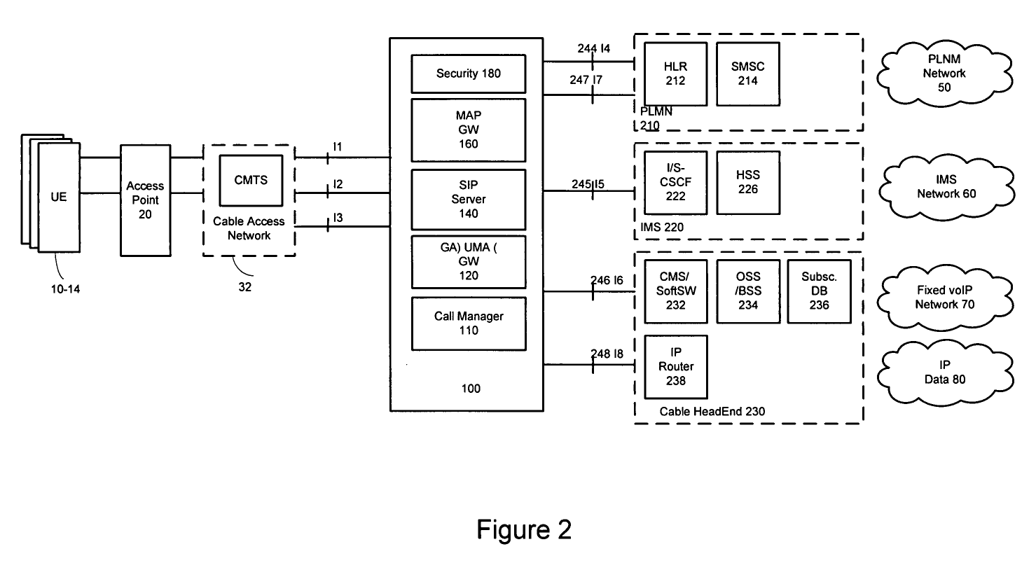

The intermediate network 30 can be a cable network. It is managed by an intermediate network manager (such as headend 230 of FIG. 2) that communicates with the intermediate server 100 in order to determine how the information is conveyed over the intermediate network. The determination can be responsive to quality of service constraints, to the type of information and the like.

The intermediate server 100 can apply a translation mechanism between a mobile phone protocol and a fixed network protocol. The translation mechanism can be selected out of a group of translation mechanisms in response to the mobile phone and fixed network that are the target and destination of the information transfer session. For example, the intermediate server 100 can apply translation mechanisms that can translate 3GPP GA, SIP, GSM, CDMA, or UMTS, to SNDCP, MAP and SIP protocols.

Intermediate server 100 includes a controller 101 that controls the various components of the intermediate server 100.

FIG. 2 is a detailed illustration of intermediate server 100 and its environment, according to an embodiment of the invention.

Intermediate server 100 is connected between an intermediate network such as cable access network 32 and between multiple network management entities such as PLMN management entity 210, IMS management entity 220 and cable headend 230.

Intermediate server 100 includes a security module 180, a MAP gateway 160, a SIP server 140, a 3GPP UA gateway 120 and a call manager 110. The intermediate server 100 is connected to the intermediate network 30 via three major interfaces - IMS provisioning and signaling interface 241, 3GPP GA provisioning and signaling interface 242 and cable network management and provisioning interface 243. In addition to these management/provisioning interfaces the intermediate network 30 is connected to the intermediate server 100 via multiple data/voice/media conveying channels.

The intermediate server 100 is connected to PLMN management entity 210 via PLMN provisioning and management interface 244 and 3GPP GA SMA message interface 247.

The intermediate server 100 is connected to IMS management entity 220 via IMS provisioning and management interface 245. The intermediate server 100 is connected to cable headend 230 via 3GPP GA SMS message interface 246 and 3GPP GA IP data interface 246. In addition to these management/provisioning interfaces the intermediate server 100 30 is connected to networks 50, 60, 70 and 80 via multiple data/voice/media conveying channels.

The cable access network 32 is controlled by cable headend 230. The cable headend also includes CMS/Softswitch 232, OSS/BSS 234, subscriber database 236 and IP router 238.

Controller 101 is adapted to control components 110, 120, 140, 160 and 180.

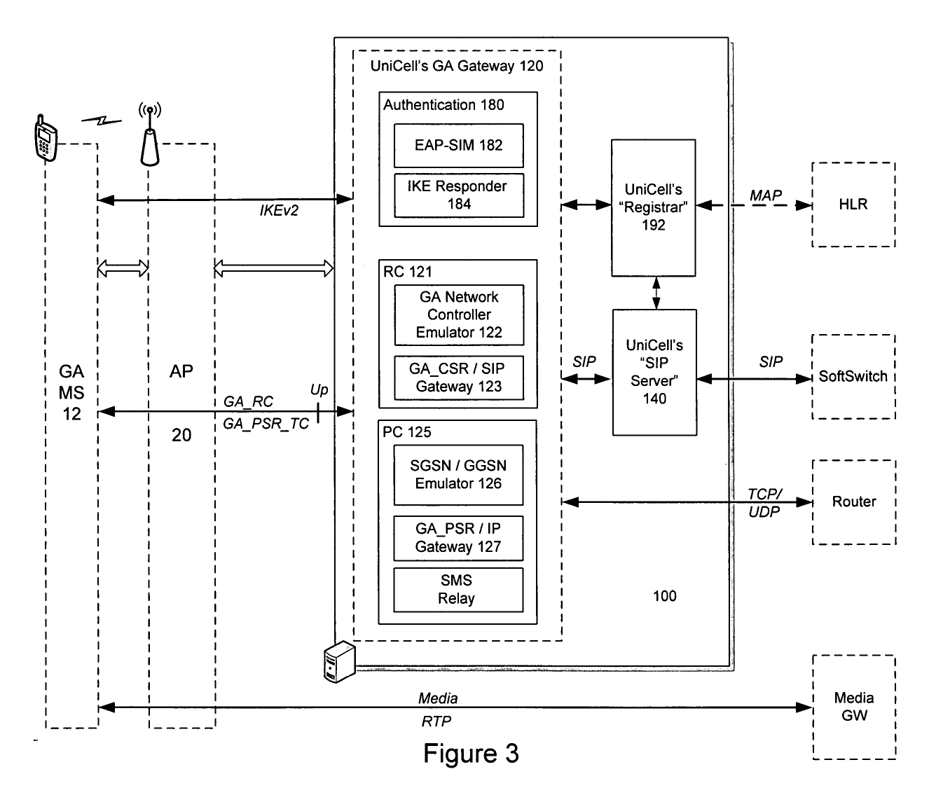

FIG. 3 is another detailed illustration of an intermediate server 100 and its environment, according to an embodiment of the invention.

For convenience of explanation FIG. 3 illustrates only the connectivity between the intermediate server 100 and a 3GPP GA mobile phone 12.

Mobile phone 12 exchanges signals with access point 20 that in turn is connected, over an intermediate network 30 to intermediate server 100. The IKEv2 link represents an authentication session that is established between mobile phone 12, over intermediate network 30 and authentication entity 180 within 3GPP GA gateway 120 that belongs to the intermediate server 100. The authentication entity 180 includes a EAP-SIM authenticator 182 and a IKE responder 184.

The 3GPP GA gateway 120 also includes an RC sub-module 121 and a PC sub-module 125. The RC sub-module 121 emulates a 3GPP GANC interface towards the mobile phone, and applies a 3GPP GA to SIP translation mechanism. The RC sub-module 121 includes a 3GPP GA network controller emulator 122 and a GA-CSR to SIP translator 123. The PC sub-module 131 emulates a 3GPP GANC interface towards the mobile phone, and applies a GA-PSR to MAP translation mechanism for SMS messages. The PC sub-module 125 includes a SGSN emulator 122 and a GA-PSR to IP translator 127 for GPRS data traffic

The 3GPP GA gateway 120 is connected to a Registrar 192 and to a SIP server 140. The Registrar 192 is connected to HLR 212 while the SIP server is connected to a Softswitch 232. A router 238 is also connected to the 3GPP GA gateway 120. In addition media streams are provided, using RTP protocol from the intermediate network 30 to a media GW 239.

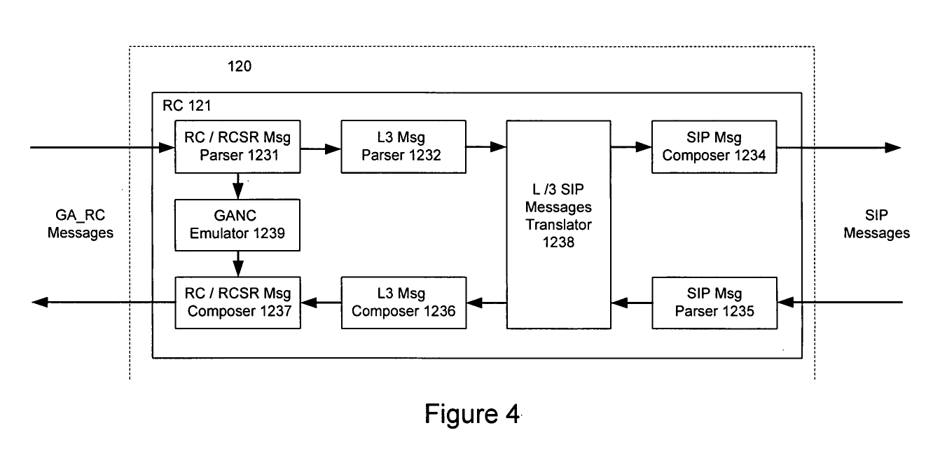

FIG. 4 is a detailed illustration of a translation component 121 according to an embodiment of the invention.

A translation component, such as RC sub-module 121 applies a translation mechanism between SIP protocol and GA-RC protocol. It includes a GA-RC to SIP translation path and a SIP to GA-RC translation path.

The GA-RC to SIP translation path includes a RC/RCSR messages parser 1231 that is followed by a L3 message parser, a layer₁₃ three SIP message translator 1238 and a SIP message composer 1234. The SIP to GA-RC translation path includes a SIP message parser 1235 that is followed by the layer three SIP message translator 1238, L3 message composer 1236 and a RC/RCSR message composer 1237. The RC/RCSR message composer 1237 is also connected via GANC emulator 1239 to the RC/RCSR massages parser 1231. This connection enables to selectively close a loop between the RC sub module and the mobile phone 12.

The GA-CSR channel between the mobile device and the GANC (Generic Access Network control) carries two types of messages: (i) the signaling message specific to the connection between the mobile device and the GANC, and (ii) the upper layer messages (GSM/CDMA/UMTS call control messages) contains within the GA-CSR messages (which acts simply as containers).

The messages of type (i) are interpreted and answered or generated by GANC daemon 1239 to simulate a fully functional GANC connected to the GSM/CDMA/UTMS cloud. The upper layer messages (type ii) received by the intermediate server 100 are parsed and converted to SIP messages. Conveniently, two types of mapping take place: (a) CC₁₃ commands converted to SIP methods (i.e CC₁₃ SETUP to SIP INVITE), and (b) CC₁₃ commands parameters to SIP header and SDP (session descriptor protocol) parameters.

The same mapping takes place in the opposite way for SIP messages received by the intermediate server 100: SIP to CC messages. A slightly different translation is applied at the data message path: SMS messages originated from the mobile device carried on the GA-PSR channel are converted to MAP messages sent/received to/from the MSC serving the operator's network. The opposite translation takes place for SMS messages received on the MAP interface of the intermediate server 100. GPRS IP data (LLC PDU) transported by the GA-PSR containers are converted to standard IP packets. It is noted that the intermediate server 100 acts as an SGSN and as a GGSN.

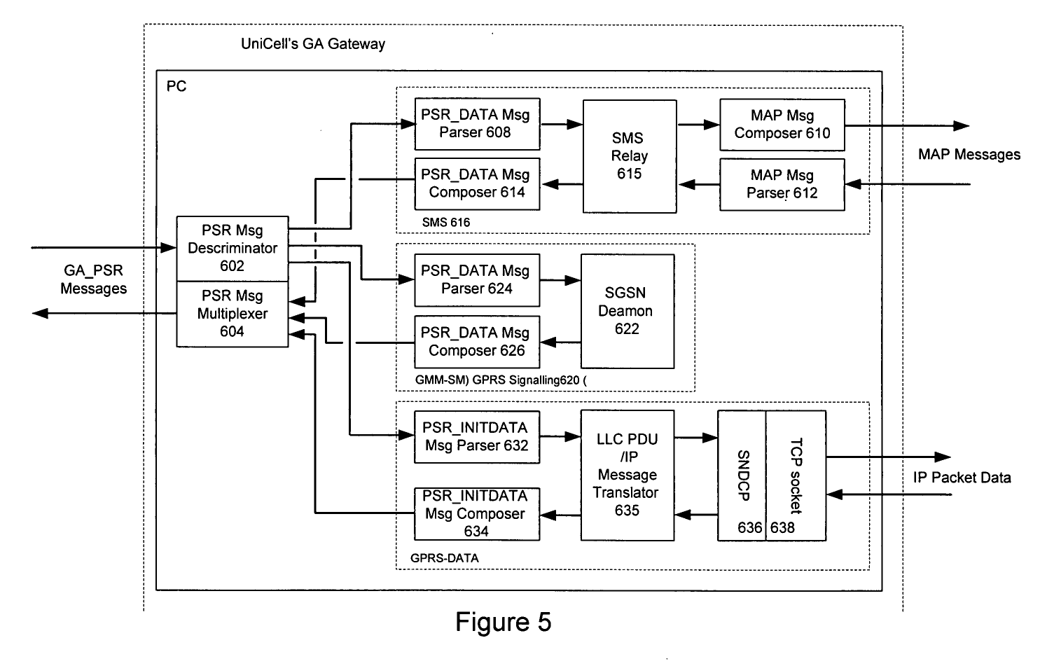

FIG. 5 is a detailed illustration of another translation component, according to an embodiment of the invention.

A translation component, such as PC sub-module 125 applies a translation mechanism between MAP protocol and GA-PSR protocol and a translation mechanism between IP protocol and GA-PSR protocol.

PC sub-module 125 includes a GA message discriminator & multiplexer 606 that is connected to the following components: PSR message parser 602, PSR message composer 604, SMS module 616, GMM-SM module 620 and GRPS-DATA module 630.

SMS module 616 includes an SMS relay 615 that is connected to PSR-DATA message parser 608, MAP message composer 610, MAP message parser 612 that is connected to a PSR-DATA message composer 614. The MAP message composer 616 is connected to HLR 212. The PSR-DATA message parser 608 and the PSR-DATA message composer 614 are connected to central bus 606.

GPRS-DATA module 630 includes a LLC PDU/IP message translator 635 that is connected to PSR-INITDATA message parser 632, SNDCP component 636 and PSR-INITDATA message composer 634. The central bus 606 is connected to the PSR-INITDATA message composer 634 and to the PSR-INITDATA message parser 632.

The SNDCP component 636 is connected to TCP socket 638 that in turn is connected to router 238.

GMM-SM module 620 includes a PSR-DATA message parser 624 that is connected between the Message Descriminator/Multiplexer 606 and a SGSN Emulator 622. The GMM-SM module 620 also includes a PSR-DATA message composer 626 that is connected between the central bus 606 and the SGSN Emulator 622.

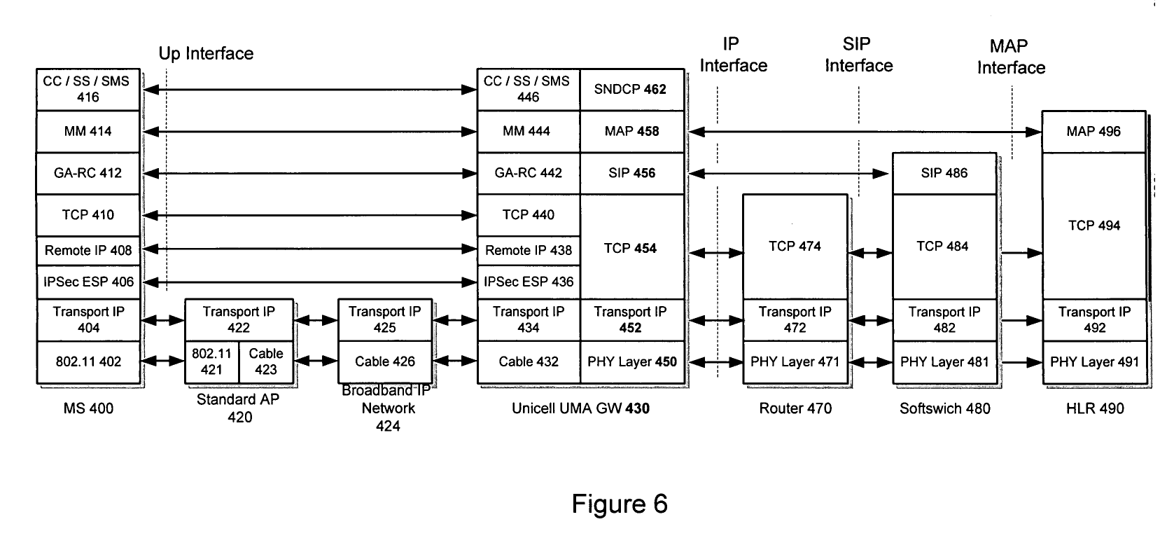

FIG. 6 illustrates various communication protocol stacks, according to an embodiment of the invention.

The mobile phone protocol stack 400 includes a CC/SS/SMS layer 416, a MM layer 414, a GA-RC layer 412, a TCP layer 410, a remote IP layer 408, an IPSec layer 406, a transport IP layer 404 and a 802.11 physical layer 402.

The access point protocol stack 420 includes a transport IP layer 422 over a physical layer that includes a 802.11 compliant layer 221 and a cable physical layer 423. The intermediate network protocol stack 424 includes a transport IP layer 425 over a cable physical layer 426.

The intermediate server 100 supports a complex protocol stack 430. The complex protocol stack includes a mobile phone compliant stack that includes: CC/SS/SMS layer 446, an MM layer 444, a GA-RC layer 442, a TCP layer 440, a remote IP layer 438, an IPSec layer 436, a transport IP layer 434 and a cable physical layer 432. The complex protocol stack also includes a fixed network compliant stack the includes: SNDCP layer 460, MAP layer 408, SIP layer 456, TCP layer 454, transport IP 452 and PHY layer 450.

Router 438 supports a router protocol stack 470 that includes a TCP layer 476, a transport IP layer 474 and a PHY layer 471. Softswitch 232 supports a soft switch protocol stack 480 that includes a SIP layer 486, a TCP layer 486, a transport IP layer 484 and a PHY layer 481. HLR 212 supports an HLR protocol stack 490 that includes a SIP layer 496, a TCP layer 496, a transport IP layer 494 and a PHY layer 491.

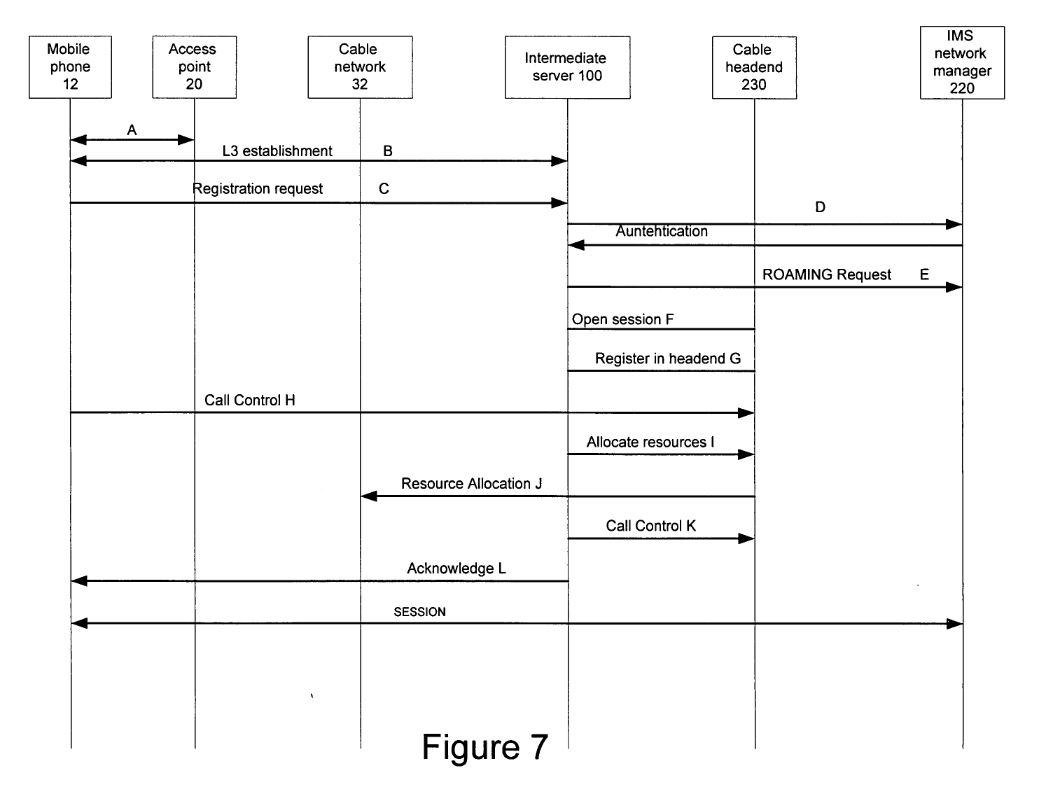

FIG. 7 illustrates various signals exchanged between the intermediate server and various entities, according to an embodiment of the invention.

An initiation session starts by an establishment (A) of a layer two L2 connection between the mobile phone 12 and the access point 20.

Then, a layer three L3 connection is established (B) between the mobile phone and the intermediate server 100.

The mobile phone then starts a registration handshake by sending a registration request (C) to the intermediate server 100. The intermediate server 100 performs an authentication handshake (D) with IMS network manager 220. A successful authentication is followed by a roaming request (E) that is sent to the IMS network manager 220. Assuming that the roaming request is successful the intermediate server 100 requests (F) from the cable headend 230 to open a session over the cable network 32 (G) the mobile phone at the headend 230. If these stages are successful then the initiation phase ends.

After the initiation phase ends the mobile phone sends a call control signals (H) to the intermediate server that can indicate the type of information to be sent. The intermediate server 100 responds by sending a request (I) to the headend 230 to allocate certain resources to the call. The request can indicate the required quality of service level for the call or can otherwise include parameters that can assist the headend 230 in determining which resources to allocate and/or the quality of service level assigned to the call. The headend 230 then sends (J) a resource allocation command or a quality of service identifier via the intermediate server 100 to the cable network 32.

The intermediate server 100 can also send call control signals (K) to the headend 230 and also send an acknowledgment signal (L) to the mobile phone 10. After these stages are completed the mobile phone starts to convey information towards the IMS network 60. During the session, the intermediate server 100 applies translation mechanisms for translating mobile phone protocols to fixed network protocols and vice verse.

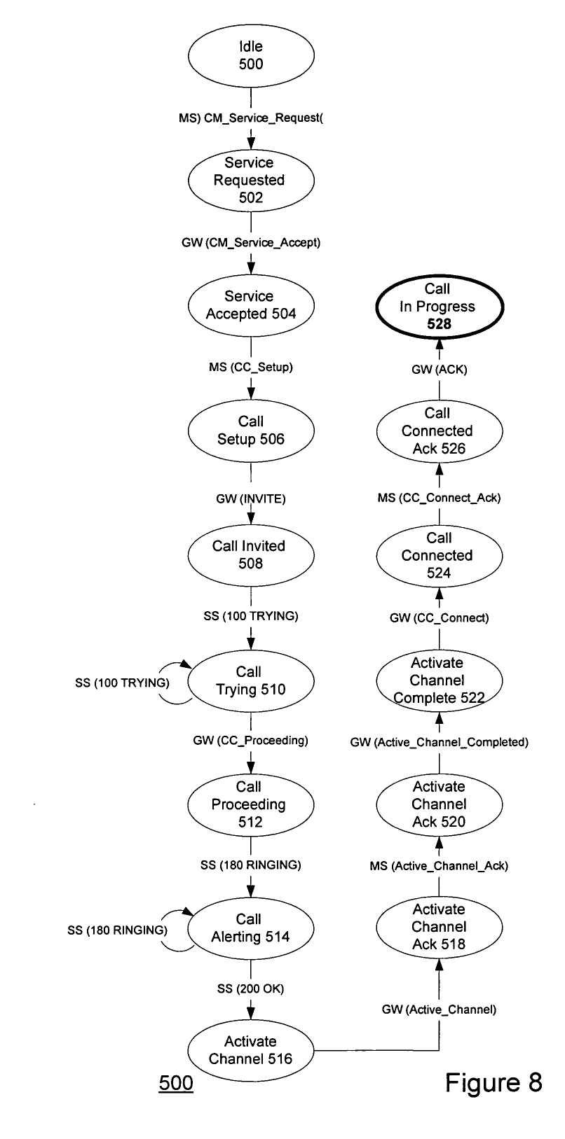

FIG. 8 illustrates a sequence 500 that controls the initialization of a call from mobile phone, according to an embodiment of the invention.

The sequence starts by idle state 500. State 500 is followed by stage 502 of receiving a service request, state 504 of accepting the request, and stage 506 of call setup. The sequence jumps from one state to another by sending or receiving GA₁₃ CSR messages. State 506 is followed by state 508 of call invited, state 510 of call trying, state 512 of call proceeding, state 514 of call alerting, state 516 of activate channel. The sequence jumps from one state to another by sending or receiving SIP messages.

State 516 is followed by activate channel, acknowledge state 518, activate channel acknowledge 520, activate channel complete state 522, cell connected 524, and cell connected acknowledge complete state 526. The sequence jumps from one state to another by sending or receiving GACSR messages. Stage 526 is followed by state 528 of call in progress.

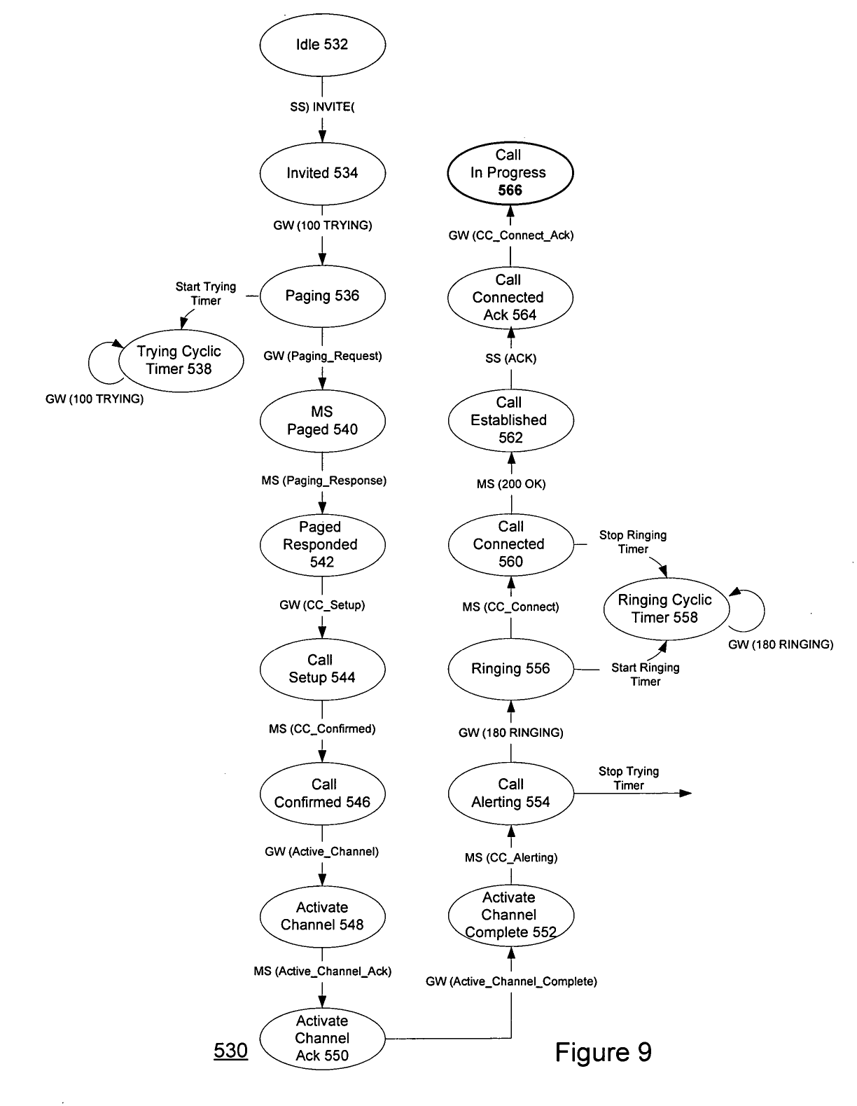

FIG. 9 illustrates a sequence 500 that controls the initialization of a call from a SIP network, according to an embodiment of the invention.

The sequence starts by idle state 532. State 532 is followed by invited state 534, paging state 536, MS pages state 540, paged responded state 542, call setup state 544, call confirmed state 546, activate channel state 548, activate channel acknowledge state 550, activate channel complete state 552, call alerting state 554, ringing state 560, call connected state 560, call established state 562, call connected acknowledgement state 564 and call in progress state 566. Sequence 530 also includes trying cyclic timer state 538 that is preceded by paging state 536 and also includes a ringing cyclic timer state 558 that can be preceded by call connected state 560 or ringing state 556. The sequence 530 jumps from states 532 to 534, from state 534 to state 536, from state 560 to state 562 and from state 562 to state 564 by sending or receiving SIP messages. The sequence jumps between other states by The sequence jumps from one state to another by sending or receiving GA₁₃ CSR messages.

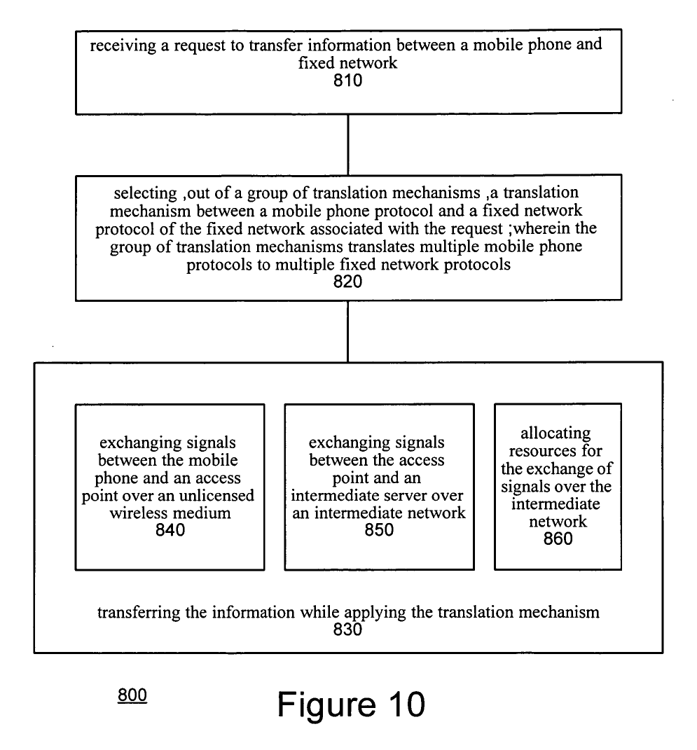

FIG. 10 is a flow chart of method 800 according to an embodiment of the invention.

Method 800 starts by stage 810 of receiving a request to transfer information between a mobile phone and fixed network.

Stage 810 is followed by stage 820 of selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols.

Stage 820 is followed by stage 830 of transferring the information while applying the translation mechanism. Stage 830 includes stage 840 of exchanging signals between the mobile phone and an access point over an unlicensed wireless medium and stage 850 of exchanging signals between the access point and an intermediate server over an intermediate network.

Conveniently, stage 830 includes stage 860 of allocating resources for the exchange of signals over the intermediate network.

According to various embodiments of the invention the allocation is responsive to a quality of service level assigned to the exchange of information and/or to a type of transferred information. For example, data voice and multimedia information can require different available bandwidth. Yet for another example information of the same type that is exchanged with different mobile phones can be assigned with a different quality of service level. This quality of service level can be determined in advance, in response to previous information exchange with that mobile phone and the like. Typically, premium clients are assigned with higher quality of service levels.

According to an embodiment of the invention stage 800 can include determining intermediate network management parameters. These parameters can reflect quality of service level but this is not necessarily so. The intermediate network management parameters can define a best path through the intermediate network, and the like.

According to an embodiment of the invention method 800 can further include applying security measurements. These security measures can include authentication, encryption, decryption and the like.

Conveniently, the group of translation mechanisms further includes a translation mechanism between a mobile phone protocol to a mobile network protocol.

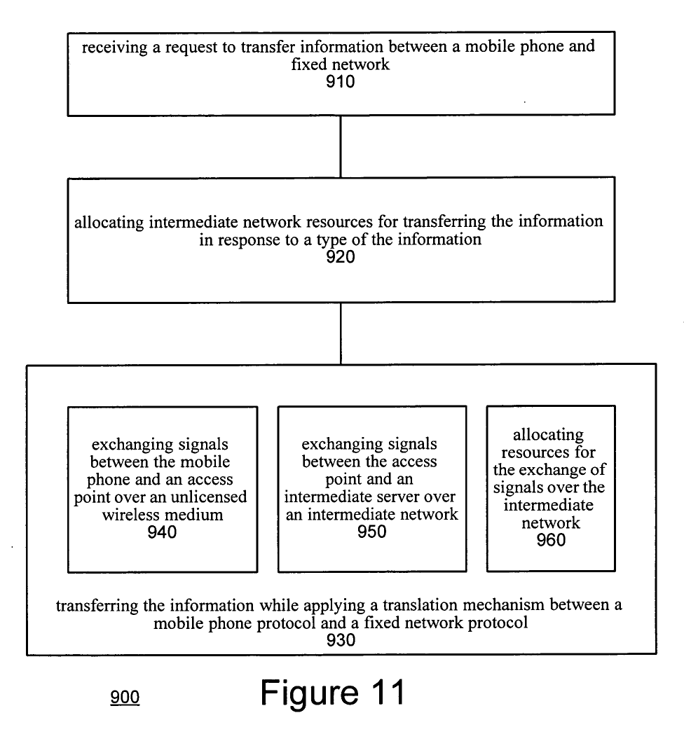

FIG. 11 is a flow chart of a method 900 according to an embodiment of the invention.

Method 900 starts by stage 910 of receiving a request to transfer information between a mobile phone and a fixed network.

Stage 910 is followed by stage 920 of allocating intermediate network resources for transferring the information in response to a type of the information.

Stage 920 is followed by stage 930 of transferring the information while applying a translation mechanism between a mobile phone protocol and a fixed network protocol. Conveniently stage 930 includes stage 940 of exchanging signals between the mobile phone and an access point over an unlicensed wireless medium and stage 950 of exchanging signals between the access point and an intermediate server over the intermediate network.

Conveniently method 900 includes selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols.

According to various embodiments of the invention the allocation is responsive to a quality of service level assigned to the exchange of information and/or to a type of transferred information. For example, data voice and multimedia information can require different available bandwidth. Yet for another example information of the same type that is exchanged with different mobile phones can be assigned with a different quality of service level. This quality of service level can be determined in advance, in response to previous information exchange with that mobile phone and the like. Typically, premium clients are assigned with higher quality of service levels.

According to an embodiment of the invention stage 900 can include determining intermediate network management parameters. These parameters can reflect quality of service level but this is not necessarily so. The intermediate network management parameters can define a best path through the intermediate network, and the like.

According to an embodiment of the invention method 900 can further include applying security measurements. These security measures can include authentication, encryption, decryption and the like.

The present invention can be practiced by employing conventional tools, methodology and components. Accordingly, the details of such tools, component and methodology are not set forth herein in detail. In the previous descriptions, numerous specific details (such as a certain compression standard) are set forth in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A method for conveying information, the method comprises the stages of:
receiving a request to transfer information between a mobile phone and a fixed network;
selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols; and
transferring the information while applying the translation mechanism; wherein the transferring comprises exchanging signals between the mobile phone and an access point over an unlicensed wireless medium and exchanging signals between the access point and an intermediate server over an intermediate network.

2. The method according to claim 1 further comprising allocating resources for the exchange of signals over the intermediate network.

3. The method according to claim 2 wherein the allocating is responsive to a quality of service level assigned to the exchange of information.

4. The method according to claim 2 wherein the allocating is responsive to a type of transferred information.

5. The method according to claim 1 further comprising determining intermediate network management parameters.

6. The method according to claim 1 further comprising applying security measurements.

7. The method according to claim 1 wherein the group of translation mechanisms further comprises a translation mechanism between a mobile phone protocol to a mobile network protocol.

8. The method according to claim 1 wherein the mobile phone protocol is selected from a group consisting of: GSM, CDMA, SIP and 3GPP GA.

9. The method according to claim 1 wherein the fixed network is selected from a group consisting of: voice over internet protocol network, internet protocol data network, and IMS network.

10. An intermediate server for conveying information, the intermediate server comprising:
an intermediate network interface, for receiving signals provided from a mobile phone to an access point and further conveyed over an intermediate network; wherein the signals are provided by the mobile phone over an unlicensed medium;
a fixed network interface, for exchanging signals with a fixed network;
at least one translation component, adapted to apply a group of translation mechanisms that translate multiple mobile phone protocols to multiple fixed network protocols; and
a controller, adapted to select a translation mechanism out of the group of translation mechanisms, in response to a request to transfer information between a mobile phone and fixed network.

11. The intermediate server according to claim 10 adapted to request a resource allocation from an intermediate network manager; wherein the resource is allocated for the exchange of signals over the intermediate network.

12. The intermediate server according to claim 11 wherein the allocation is responsive to a quality of service level assigned to the exchange of information.

13. The intermediate server according to claim 11 wherein the allocation is responsive to a type of transferred information.

14. The intermediate server according to claim 10 further adapted to affect intermediate network management parameters.

15. The intermediate server according to claim 10 further adapted to apply security measurements.

16. The intermediate server according to claim 10 wherein the group of translation mechanisms further comprises a translation mechanism between a mobile phone protocol to a mobile network protocol.

17. The intermediate server according to claim 10 wherein the mobile phone protocol is selected from a group consisting of: GSM, CDMA, SIP and 3GPP GA.

18. The intermediate server according to claim 10 wherein the fixed network is selected from a group consisting of: voice over internet protocol network, internet protocol data network, and IMS network.

19. A method for conveying information, the method comprises the stages of:
receiving a request to transfer information between a mobile phone and fixed network;
allocating intermediate network resources for transferring the information in response to a type of the information; and
transferring the information while applying a translation mechanism between a mobile phone protocol and a fixed network protocol wherein the transferring comprises:
exchanging signals between the mobile phone and an access point over an unlicensed wireless medium and
exchanging signals between the access point and an intermediate server over the intermediate network.

20. The method according to claim 19 wherein the allocating is further responsive to an identity of the mobile phone.

21. The method according to claim 19 wherein the allocating is responsive to a quality of service level assigned to the exchange of information.

22. The method according to claim 19 further comprising applying security measurements.

23. The method according to claim 19 further comprising selecting, out of a group of translation mechanisms, a translation mechanism between a mobile phone protocol and a fixed network protocol of the fixed network associated with the request; wherein the group of translation mechanisms translates multiple mobile phone protocols to multiple fixed network protocols.

24. An intermediate server for conveying information, the intermediate server comprising:
an intermediate network interface, for receiving signals provided from a mobile phone to an access point and further conveyed over an intermediate network; wherein the signals are provided by the mobile phone over an unlicensed medium; wherein the intermediate network interface is further adapted to communicate with an intermediate network manager such as to guarantee an allocation of intermediate resources to the exchange of signals;
a fixed network interface, for exchanging signals with a fixed network; and
at least one translation component, adapted to apply translation mechanisms from a mobile phone protocol to a fixed network protocol.

25. The intermediate server according to claim 24 wherein the allocation is further responsive to an identity of the mobile phone.

26. The intermediate server according to claim 19 wherein the allocation is responsive to a quality of service level assigned to the exchange of information.

27. The intermediate server according to claim 19 further adapted to apply security measurements.

28. The intermediate server according to claim 19 further adapted to select, out of a group of translation mechanisms, a translation mechanism between a mobile phone protocol and a fixed network protocol of the fixed network associated with the request; wherein the group of translation mechanisms translates multiple mobile phone protocols to multiple fixed network protocols.
